(19) United States
(12) Patent Application Publication
(10) Pub. No.: US 2009/0132677 A1
(43) Pub. Date: May 21, 2009

(54) Apparatus, system and method for automated coronary artery disease testing and analysis

(76) Inventors: Ronen Arbel, Tel Aviv (IL); Yoram Tal, Tel Aviv (IL); Michael Ortenberg, Kfar Yona (IL)

Correspondence Address: Pearl Cohen Zedek Latzer, LLP, 1500 Broadway, 12th Floor, New York, NY, 10036, US

(21) Appl. No.: 11/984,251

(22) Filed: Nov. 15, 2007

(51) Int. Cl. G06F 17/30; G06F 3/00; G06F 15/16

(52) U.S. Cl. 709/217; 710/1; 707/104.1; 707/E17.009; 707/E17.044

(57) ABSTRACT

Apparatus, system, and method for acquiring data from a subject and, based on acquired data, computing indicators and results. The method comprises guiding a subject to perform a predefined protocol and further comprising acquiring data while supervising proper execution of the protocol. The method may comprise validating data acquired, communicating data acquired to a remote analysis server, calculating indicators and results by the remote analysis server and communicating indicators and results to an initiator of the process. Apparatus may include a data acquisition device to acquire data from a subject and a processor to receive and process the data. A system may include a data acquisition device to acquire data from a subject, a data acquisition computer, and a remote analysis server in communication with the data acquisition computer.

### BACKGROUND OF THE INVENTION

Coronary artery disease (CAD) is a chronically progressive disease characterized by the presence of atherosclerosis in the epicardial coronary arteries. CAD is a major public health problem, and is important not only because of its prevalence but also because of its associated morbidity and mortality rates.

Noninvasive procedures for identifying patients with stress-induced ischemia, especially those at high risk for adverse outcome, may be used for risk stratification. Examples for such noninvasive procedures may be computational processing of digitized electrocardiographic (ECG), a time-frequency analysis of heart sounds and noninvasive imaging techniques. However, noninvasive procedures for identifying CAD are typically complicated and time consuming, typically involving expensive, complicated equipment, as well as lengthy preparation of patients, long data acquisition periods, and possibly complicated data analysis processes. Moreover, well trained and/or professional personnel may be required in order to conduct many of these procedures.

### SUMMARY OF EMBODIMENTS OF THE INVENTION

Embodiments of the invention may enable a noninvasive, simple and fast cardiovascular system analysis procedure to be performed. According to embodiments of the invention, following an installment of one or more data acquisition devices, data acquisition may begin. A subject may then be instructed to perform a predefined protocol, for example, a breathing protocol or a physical exercise protocol.

According to some embodiments of the invention, computer software may provide guidance and/or help in performing the protocol by providing ongoing instructions and/or indications to the subject. For example, the subject may be instructed when to inhale, hold his/her breath or exhale, or perform certain physical exercises.

According to some embodiments of the invention, verification of proper execution of the protocol may be performed by computer software, for example, as described herein. Data acquired from the subject may be used in order to verify proper execution of the protocol. According to some embodiments of the invention, such verification may be performed during execution of the protocol. In other embodiments of the invention, verification may be performed upon termination of data acquisition.

According to some embodiments of the invention, data may undergo an initial analysis phase in which it may be determined whether various indicators may be derived from the data. For example, the presence of power peaks around predefined frequencies may be verified.

According to some embodiments of the invention, acquired data may be sent to a remote server, and such server may perform further analysis of the data, compute various indicators and/or parameters and derive results. According to some embodiments of the invention, the remote server may be in communication with a database or other data repository. Such repository may contain data acquired from a large number of subjects. According to some embodiments of the invention, analysis performed by the remote server may involve statistical or other calculations involving data in the database. Relevant information may further be communicated by such server, possibly by mail or other methods, to a designated recipient, for example, the medical doctor or other person who ordered the procedure or the patient.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows an exemplary, high-level diagram of a setup according to embodiments of the invention;

FIG. 2 shows an exemplary flow according to embodiments of the invention; and

FIG. 3 shows an exemplary calibration procedure flow according to some embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Unless explicitly stated, the method embodiments described herein are not constrained to a particular order or sequence. Additionally, some of the described method embodiments or elements thereof can occur or be performed at the same point in time.

The present invention relates to a process or test procedure that may be employed in order to assess a subject's health condition. According to some embodiments of the invention, the process may comprise subjecting a patient to a set of controlled conditions and then evaluating the response of various system, such as the cardiovascular system, to the controlled conditions.

According to some embodiments of the invention, the process may comprise a data acquisition procedure, data analysis, calculation of results and presentation of results. According to some embodiments of the invention, different steps comprising the process may be performed by different personnel and/or different computers as well as possibly at different times and/or different locations. The terms process, test and test procedure may be used interchangeably hereafter.

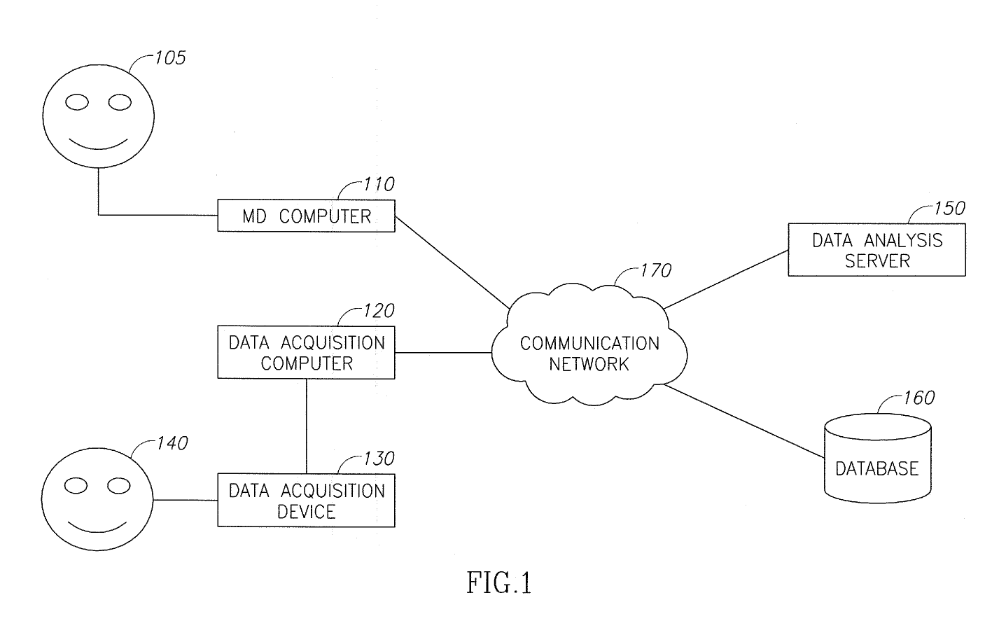

Reference is made to FIG. 1 showing a possible setup according to some embodiments of the invention. According to some embodiments of the invention, a test requester 105 may recommend or schedule a test for patient 140. The test requester may be a medical doctor or other professional, a health maintenance organization (HMO), a health insurance carrier, etc. It will be understood that in the following description a medical doctor (MD) is used as a non-limiting example, and anyone suitably authorized may request a test according to embodiments of the invention. According to some embodiments of the invention, medical doctor (MD) 105 may perform some parts of the process, for example, in his/her clinic, possibly using computer system 110 as well as other necessary equipment (not shown) that may be present at the clinic. In other embodiments of the invention, MD 105 may schedule the test procedure to be performed in a suitable facility at some future date. According to some embodiments of the invention, MD 105 may attach various patient details and/or information to a test request. For example, relevant medical and/or other information regarding patient 140 may be attached to a test request, which patient information may be used in order to calculate results and/or for statistics gathering. For example, patient's age, gender, medical history, known conditions, drug and/or medicine consumptions may be attached to a test procedure request. According to some embodiments of the invention, additional information that may be added by MD 105 or computer 110 may be information identifying MD 105 or computer 110, and such information may be used by various entities participating in the process, for example in order to route results back to MD 105 or computer 110.

According to some embodiments of the invention, MD 105 may use computer 110 in order to schedule a test procedure. For example, MD 105 may use electronic mail in order to communicate a request to a suitable institution to perform the procedure, MD 105 may attach patient information, as described earlier to a request for a test procedure. According to some embodiments of the invention, computer 110 may communicate the request and/or other information over communication medium 170. Communication medium 170 may be any suitable medium such as, but not limited to, a private internet protocol (IP) network, a local area network (LAN) or a wide area network (WAN) such as the internet.

According to some embodiments of the invention, computer 120 may be located at an institution that performs the test procedure. For example, computer 120 may be located at a hospital, a clinic or any other suitable, possibly medical institution. According to some embodiments of the invention, a scheduling system (not shown) may provide computer 120 with necessary details regarding patient 140, for example, details provided by MD 105 as described earlier or details obtained from other sources, for example, a hospital's database or an electronic patient file.

According to some embodiments of the invention, data acquisition device 130 may be connected to computer 120. Connection between data acquisition device 130 and computer 120 may be accomplished by various means, such as, but not limited to, universal serial bus (USB), serial line, wired network, for example, IEEE 802.3, or wireless network, such as wireless fidelity (WiFi), IEEE 802.11, Bluetooth™ connections or any other suitable communication medium. Data acquisition device 130 may be any suitable sensing device, such as but not limited to one or more of a photoplethysmograph sensor, a flow sensor, a mechanical sensor, an optical sensor, an ultrasonic sensor or an electrical impedance sensor, or any combination of the foregoing. According to some embodiments of the invention, data acquisition device 130 may be a noninvasive device while according to other embodiments of the invention data acquisition device 130 may be an invasive device. According to some embodiments of the invention, data acquisition device 130 may further be placed on patient 140 such that data acquisition may be performed. Placement of data acquisition device 130 may be done according to specifications and/or type of data acquisition device 130. According to some embodiments of the invention, data acquired by data acquisition device 130 may be patient vital signs such as, but not limited to electrocardiogram (ECG), blood pulse wave (PW) or any other suitable, measurable activity.

In one embodiment of the invention, the method, apparatus and/or system described in US Patent Application Publication No. 2007/0021673, which is commonly assigned to the assignee of the present application, may be used.

According to some embodiments of the invention, data acquired by data acquisition device 130 may be digitized by data acquisition device 130 where necessary, and communicated to computer 120. According to some embodiments of the invention, computer 120 may perform analysis of the data acquired, calculation of results as well as presentation of results. According to other embodiments of the invention, computer 120 may receive data from data acquisition device 130 and may further communicate the data to data analysis server 150. Computer 120 may further store data received from data acquisition device 130 for further and/or future use. According to some embodiments of the invention, computer 120 may further communicate additional data and information to analysis server 150. For example, patient demographic data may be communicated by computer 120 to server 150 as well as other information. Information communicated by computer 120 to server 150 may arrive, or be retrieved, from various sources, for example, information may be provided by MD 105 as described earlier, or it may come from a hospital database (not shown), or it may be entered, possibly manually, by an operator of computer 120. According to some embodiments of the invention, computer 120 may communicate with server 150 over communication medium 170. Communication medium 170 may be any suitable communication medium as described earlier.

According to some embodiments of the invention, data analysis server 150 may receive data from a plurality of computers such as computer 120. Server 150 may perform analysis of the received data, as well as calculate results. Server 150 may further communicate results to a designated recipient, for example, server 150 may return results to the source of the data, for example, computer 120. According to other embodiments of the invention, data received by server 150 may contain details and/or information that may be used by server 150 in order to communicate results to the correct destination, for example, although raw data may be communicated from computer 120 to server 150, server 150 may return results to computer 110, i.e. to MD 105. It will be understood that in the foregoing, and throughout the present application, the results need not be sent to a particular computer 120, but may be provided to an account accessible by computer 120. Thus, for example, the results may be placed on a server accessible by a login identification and password of a medical doctor or other test requester, and the results may be accessed or otherwise downloaded from the server to computer 120.

Server 150 may use data stored in database 160 in order to derive results. For example, some results provided by server 150 may be in relative or probability form. For example, at least a portion of a test result may be a probability between 0 and 100% of the occurrence of a particular medical incident or event. Another example may be a contingency risk factor that may be calculated. Deriving such results may involve, or be accomplished by utilizing information stored in a database 160. Database 160 may contain data, information and/or results of a large number patients. Information stored in database 160 may further be arranged, retrieved or sorted according to specific needs or requirements imposed by calculations performed by server 150. For example, information in database 160 may be sorted according to patient age, gender, medical history or specific diseases.

According to some embodiments of the invention, server 150 may store information in database 160, which information may be used by server 150 as described earlier. According to some embodiments of the invention, storage of information in database 160 may be done while reducing or eliminating risks of compromising patient privacy. For example, patient name, address or other identifying, personal details may be omitted from data stored in database 160 and a numeric code or other record identification may be used. A central secure database may contain the private user identification associated with each record identifier.

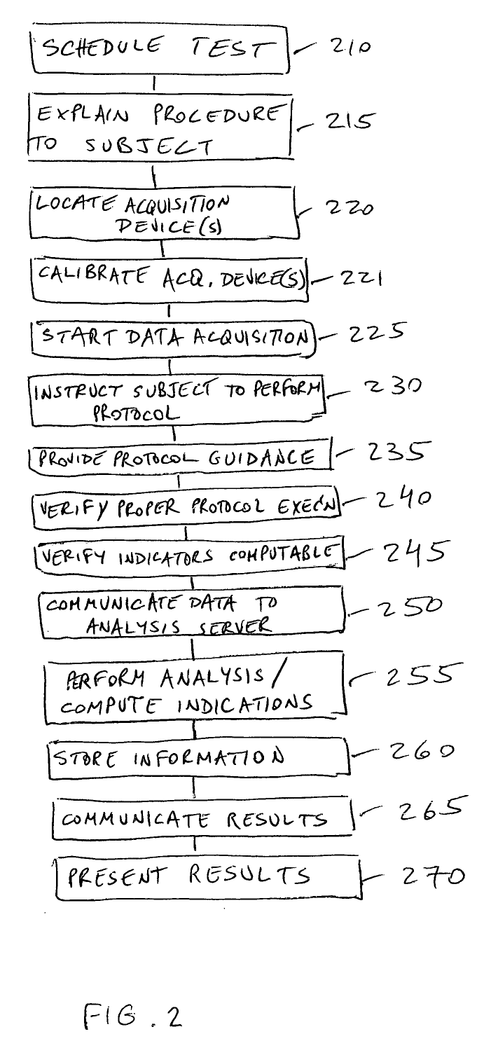

Reference is made to FIG. 2 showing an exemplary process flow according to embodiments of the invention. According to embodiments of the invention, the process may begin by scheduling a test for a patient (210), scheduling may be done by a medical doctor as part of a routine checkup. In other cases, a decision to initiate the process may be based on medical findings, possibly indicating various risks or conditions that may call for further examinations. According to embodiments of the invention, scheduling a test may comprise some preliminary tests or medical examinations, the results of such preliminary examinations may be communicated with the test request and may be used during various steps comprising the process. In addition, a patient's electronic medical file or other relevant medical information may be obtained as part of the test scheduling step, such information may also be communicated with the test request and may be used during various steps comprising the process. According to embodiments of the invention, scheduling a test may further comprise sending a request to a scheduling system or directly to the institution or facility that performs the test. A scheduling system may be able to schedule a test at a date and location best suited for the patient, for example, a scheduling system may select the facility closest to the patient's home.

According to embodiments of the invention, the process may include explaining the procedure to the patient (215), this step may be performed at the facility where data acquisition is performed, for example, by the personnel supervising the data acquisition step and/or using an automated audiovisual presentation. According to some embodiments, explanation of the procedure to the patient may be made to the user via a personal computer connected to a network, for example, the Internet.

According to embodiments of the invention, data acquisition may be an automated procedure. The personnel supervising this step need only require limited training and need not be highly trained medical professionals. Following an explanation of the procedure to the patient, which may be performed locally or remotely, data acquisition devices may be properly located (220). Locating of the data acquisition device or devices may be done according to the type of data being acquired and/or the acquisition devices. An illustrative, non-exhaustive list of examples of data type that may be measured and acquired may be: blood flow, blood volume, blood pressure and/or electrocardiographic (ECG). Accordingly, data acquisition devices may vary as well as the location and/or installment of the data acquisition devices. For example, according to some embodiments of the invention, a pulse oximetry sensing device may be used, in which case, a sensing device may be placed on a patient's body extremity, including, but not limited to—a finger, ear, neck, wrist, toe, ankle, or chest.

According to embodiments of the invention, specialized computer software may be invoked after acquisition devices are properly placed, which computer software may control, manage or otherwise supervise the data acquisition phase of the process. This software may be referred to hereafter as the data acquisition management software. According to some embodiments of the invention, the data acquisition management software may comprise several processes, execution threads, tasks or any other suitable software entities. Software entities comprising the data acquisition management software may run simultaneously, in parallel or serially. A central task or process may supervise and/or manage aspects such as, but not limited to, invocation, scheduling, execution and/or intercommunication of such processes, tasks or threads.

According to some embodiments of the invention, the data acquisition management software may verify that the data acquisition devices are properly located. Such verification may be performed by comparing signal strength and/or signal quality received from the acquisition devices to a predefined signal level and/or signal quality. According to embodiments of the invention, the data acquisition management software may control, manage or otherwise supervise the data acquisition devices, for example, the data acquisition management software may issue commands to the data acquisition devices, such commands may be start/stop acquisition, change signal strength, apply filters, change configuration or any other commands that may be supported by the data acquisition devices, additionally, the data acquisition management software may receive input from the data acquisition devices, process such input and issue commands to the data acquisition devices. Commands issued by the data acquisition management software to the data acquisition devices may depend, at least in part, on input received from the data acquisition devices.

According to embodiments of the invention, metadata may be stored as well as acquired data. Metadata may be stored by the data acquisition management software. For example, time-event correlation metadata may be stored during different data acquisition phases. Such metadata may enable correlating time and/or events to specific locations in an acquired data stream. For example, the different phases comprising the data acquisition part of the process may be marked by metadata, such marking may enable future stages of the process to manipulate, handle or analyze data correctly.

According to embodiments of the invention, possibly after proper placement and/or location of the data acquisition devices has been verified, the data acquisition management software may initiate a calibration procedure as indicated by block 221. One possible calibration process will be described in detail further below.

According to embodiments of the invention, possibly after a successful calibration procedure, data acquisition (225) may be initiated. Initiation of data acquisition may comprise commanding one or more data acquisition devices to communicate acquired data to a remote computer. According to embodiments of the invention, data acquired may be stored locally for future use, or in order to be communicated at a later stage, for example, when a connection to a suitable communication network is made. In other embodiments of the invention, data acquired may be immediately communicated, for example to a remote computer, possibly for storage and/or further analysis.

According to embodiments of the invention, data acquisition may comprise several phases. In some embodiments of the invention, such phases may require active participation of the patient. According to embodiments of the invention, the patient may be required to execute a predefined protocol, for example a breathing protocol.

According to embodiments of the invention, the patient may be instructed to perform a protocol (230). In some embodiments of the invention, the data acquisition management software may issue instructions to the patient, for example using a computer display and/or speakers. Instructions issued to the patient by the data acquisition management software may comprise any suitable content, such as, but not limited to, text, graphics, audio and/or video. For example, numeric readings may provide a subject with indications as to how long a given step has to be performed and/or the time remaining till end of a specific step or phase of the protocol, or a sound may be played at an end and/or beginning of a step or phase comprising the protocol. If the protocol to be performed by the patient is a breathing protocol then a human voice may be sounded, instructing the patient to inhale, hold his/her breath and exhale, or a progress bar may be displayed, possibly in different colors for inhaling and exhaling, or a clock showing number of seconds elapsed or remaining for each step may be shown.

According to embodiments of the invention, data acquired may be continuously examined and/or analyzed, particularly during execution of the protocol. Such monitoring of the acquired data may be performed by the data acquisition management software. According to embodiments of the invention, such examination may enable verification of proper execution of the protocol by the patient prior to storage or transmission of the data for analysis. According to some embodiments of the invention, feedback or guidance regarding execution of the protocol may be provided to the patient (235). For example, data acquisition management software may detect that a patient is breathing too slowly or too rapidly according to a predefined breathing protocol, in which case the data acquisition management software may instruct the patient to increase or decrease his/her breathing rate, respectively. According to embodiments of the invention, the data acquisition management software may instruct the patient to continue performing the protocol until sufficient data has been acquired. According to some embodiments of the invention, under proper conditions, data acquisition time may be relatively short, for example, under 100 seconds.

Executing a controlled breathing protocol by a patient may be one of various ways of subjecting a patient to controlled environment and/or conditions. According to some embodiments of the invention, subjecting the patient to controlled conditions as described earlier may comprise, for example, visual effects, audio effects or temperature changes. According to embodiments of the invention, the data acquisition management software may control these conditions and/or effects, for example, using one or more suitable peripheral devices, such as a monitor display, speakers, a heating or cooling device, etc. According to embodiments of the invention, the data acquisition management software may analyze acquired data in order to determine how these conditions affect the patient. The data acquisition management software may further change, configure, tune or otherwise alter the conditions in order to achieve an optimal response of the measured biological system, for example, the cardiovascular system. According to embodiments of the invention, once optimal response is achieved, the actual measurement may be performed. According to embodiments of the invention, metadata, possibly stored by the data acquisition management software may enable the separation or identification of data acquired during a tuning phase and data acquired during an actual test.

According to embodiments of the invention, data acquired may be analyzed (240). Such analysis may be performed in order to verify proper protocol execution and/or that conditions to which the patient was subjected have yielded the desired effect. According to embodiments of the invention, data acquired may further be analyzed in order to determine that various indicators and/or results may be computed based on the acquired data (245). According to embodiments of the invention, if analysis at this stage shows that some or all indicators and/or results may not be computed based on the acquired data then the data acquisition management software may provide a suitable notification and/or an instruction to repeat the protocol. For example, the operator may be advised by the data acquisition management software of possible further actions, such further actions may be to repeat the test, check connections and/or wiring, change some configuration and/or conditions or, in some cases, to postpone or cancel the process.

According to embodiments of the invention, data acquired, metadata and/or other patient information may be communicated to an analysis server (250). According to embodiments of the invention, data communicated may be encrypted prior to being communicated, possibly in order to protect patient privacy. Some or all data communicated may further be compressed, possibly, in order to save communication bandwidth. According to embodiments of the invention, details identifying the patient, such as patient name and/or patient address may be excluded from the communication to the analysis server. According to embodiments of the invention, a unique test identification number or string may be associated with and incorporated into data communicated to the analysis server. Such test identification may be used at later stages in order to associate information such as results with the patient. According to embodiments of the invention, the test identification may also be communicated to the requester of the test. For example, if the test was requested or scheduled by a medical doctor as shown by 210 then the test identification may be communicated to the requesting medical doctor, possibly with the patient name or other identifying details. Such communication to the requesting entity may serve as an indication that the data acquisition step of the process has been completed as well as providing reference to results that may be received at later stages of the process. For example, as describe below, results may be communicated to the requesting medical doctor with the test identification. According to embodiments of the invention, the test identification may be a unique code generated by the data acquisition management software and stored in a database.

According to embodiments of the invention, the analysis server may be located in close proximity to the location where data acquisition is performed, for example, in the same medical institution. In such case, data may be communicated over a local area network (LAN) or over a wireless network to the analysis server. In other embodiments of the invention, the analysis server may be located distantly, for example in another location, such as for example, a nearby room, another state or another continent.

According to embodiments of the invention, data communicated may be received by an analysis server where data analysis, computations and/or calculations of various indicators and/or results may be performed (255). According to embodiments of the invention, computations, calculations and/or any other manipulations performed at stage 255 may involve information stored in a database or any other suitable repository. For example, a database containing data, results and/or indicators pertaining to a large number of patients may be used in order to compare, rate or otherwise evaluate data at stage 255. According to embodiments of the invention, information such as acquired data, results and/or indicators derived at stage 255 may be stored (260), possibly for future use. Such storage may be at the same database or repository used for the calculations performed as shown by 255.

Indicators, results and other information may be communicated (265). According to embodiments of the invention, results, indicators and/or other information may be communicated to the process requesting entity, for example, to a medical doctor who initiated the process as shown by 210. According to embodiments of the invention, communication at 265 may include a test identification as well as billing information. Communicating results and other information with the associated test identification may be used by the receiving end in order to associate the information communicated with a specific patient. According to embodiments of the invention, billing information may comprise a listing of procedures performed as well as other information pertaining to billable actions and/or procedures that may have been performed.

According to embodiments of the invention, indicators, results and/or other information may be presented (270). For example, information communicated as shown by 265 may be received and presented by a medical doctor or other personnel who ordered the procedure. According to embodiments of the invention, presentation of the information may be done by a specialized computer software or by standard applications. According to embodiments of the invention, presentation of the information may comprise tables, graphs or other presentation means.

According to some embodiments of the invention, the process may comprise a calibration procedure as indicated by 221 (FIG. 2). A calibration procedure may be required in order to adapt the input signal to the system measurement range. For example, when using data acquisition devices that rely on infrared light absorption by tissues, factors such as, but not limited to tissue opacity or ambient lighting may influence the acquired signal. Moreover, as described earlier, the process may comprise execution of a protocol by the subject being tested, for example, a breathing protocol. The amplitude of the signal acquired may vary during execution of such protocol, and such amplitude variations may cause the acquired signal to be out of an operational range and consequently produce incorrect measurements and/or results.

According to some embodiments of the invention, the calibration procedure as well as the method may depend on factors such as but not limited to the subject being tested, the environment (e.g. light, temperature, humidity etc.) and the data acquisition devices used. For example, when using some data acquisition devices, the acquired signal may be attenuated or intensified in order to achieve the desired signal strength. According to other embodiments of the invention, if the data acquisition device comprises measuring the absorption of infrared light emitted by a light emitting diode (LED), then calibration may comprise varying the voltage applied to the LED, consequentially varying the luminescence of the LED such that the output signal is in a suitable range.

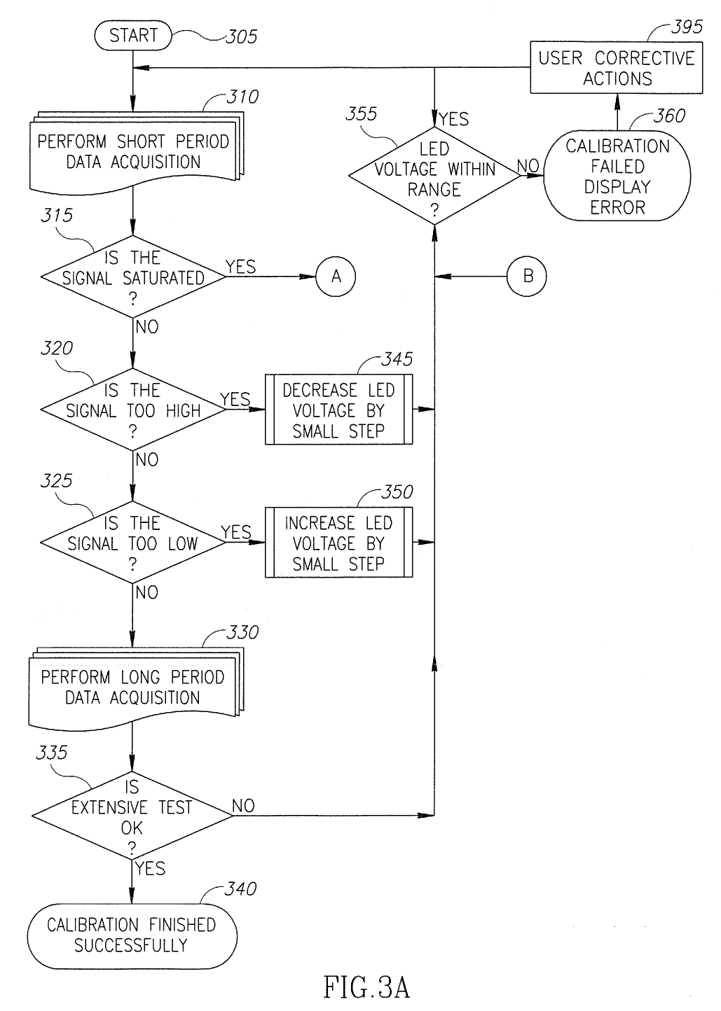

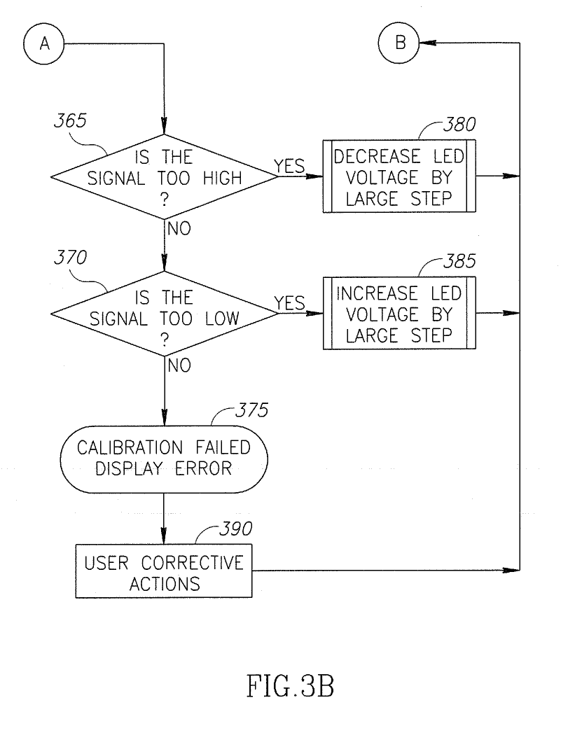

Reference is made to FIG. 3 which shows an exemplary calibration procedure flow according to some embodiments of the invention. The flow as depicted in FIG. 3 relates to a calibration of a pulse oximetry device. Such device may measure absorption by tissues of light emitted by a light emitting diode (LED). Other data acquisition devices may be used in other embodiments of the invention, in which case the flow may vary in some respects without departing from the scope of the invention. For example, acquisition durations may vary, or signal attenuation or intensification methods may vary, etc.

According to some embodiments of the invention, the flow may begin as indicated by block 305. According to some embodiments of the invention, the flow may be initiated by an operator, possibly after data acquisition devices have been properly placed or fitted. According to some embodiments of the invention, the acquisition device may be set at this stage to its default settings. For example, if the acquisition device comprises a LED then the voltage applied to the LED may be set to a default or midrange value, for example, three (3) volts (3V).

According to some embodiments of the invention, the flow may include a short period of data acquisition as indicated by block 310. For example, an acquisition period of two (2) seconds may be used at this stage. Duration of this stage may vary, for example according to acquisition devices used, signal strength and/or signal quality. According to some embodiments of the invention, acquired data may be examined as indicated by block 315. Examination and/or verification of the acquired data may include, among other criteria, verification that the signal received from the data acquisition device is not saturated. A saturated signal may indicate conditions such as, but not limited to, values that are out of an operational range in respect to the measurement capacity of the system and/or a faulty component. According to some embodiments of the invention, saturation of the signal may be detected by various methods. For example, if the acquired signal has no distinctive maximum and minimum values then it may be considered a saturated signal. According to some embodiments of the invention, additional conditions may be required to be met in order for a signal to be considered non-saturated. For example, the signal's mean value may be required to be around a predefined value, for example, a median or an average of a predefined measurement range.

According to some embodiments of the invention, and as indicated at block 320, if the signal is not saturated, the signal may be examined in order to verify it is not too high or above a predefined value. As indicated by block 345, if the signal is found to be too high then the voltage applied to the LED may be decreased by a small amount. For example, in some embodiments of the invention, the signal may be decreased by 0.25 volts. According to some embodiments of the invention, possibly following a decrease of the voltage applied to the LED, the voltage may be examined as shown by block 355. Such examination may be performed in order to verify that the voltage applied to the LED is still within operating range of the specific LED. An operating voltage range may vary from one device and/or LED to another, for example, a LED's voltage range may be 1.7 volts to 4.5 volts. According to some embodiments of the invention, if the voltage applied to the LED is found to be out-of-range, for example, if the voltage is above or below the operating range of the specific LED used by the data acquisition device, then it may be concluded that calibration has failed as indicated by block 360. According to some embodiments of the invention, such calibration failure may comprise issuing an error indication to a user, where such indication may comprise suggestions for further actions. Such further actions, as indicated by block 395, may be, for example, relocating the data acquisition device, protecting the sensor from external illumination, checking connections and/or wiring, or otherwise changing and/or altering the test conditions. According to some embodiments of the invention, following a decrease of the applied voltage (345) and a verification that the voltage is in range (355) the flow may return to the short acquisition period step as shown by block 310.

According to some embodiments of the invention, if the signal acquired during the short acquisition period is not saturated it may further be checked to see if it is not too low as indicated by block 325. According to some embodiments of the invention, if the signal is found to be too low then the voltage applied to the LED may be increased by a small amount. For example, in some embodiments of the invention, the signal may be increased by 0.25 volts. According to some embodiments of the invention, following an increase of the voltage applied to the LED, the voltage may be examined as shown by block 355. Such examination may be performed in order to verify that the voltage applied to the LED is still within operating range of the specific LED. According to some embodiments of the invention, following an increase of the applied voltage (350) and a verification that the voltage is in range (355) the flow may return to the short acquisition period step as shown by block 310.

According to some embodiments of the invention, if the signal acquired during the short acquisition period is not saturated and is further within a predefined range, then a long acquisition period may be performed as shown by block 330. According to some embodiments of the invention, a long acquisition period may vary according to various conditions and parameters, such as, but not limited to, signal quality, or the sampling rate of the acquisition device. For example, according to some embodiments of the invention, a long acquisition period may be seven (7) seconds.

According to some embodiments of the invention, following a long acquisition period the signal may be analyzed as indicated by block 335. According to some embodiments of the invention, such analysis may be performed in order to verify that various parameters and/or indicators can be calculated, computed or derived based on the acquired data. For example, the presence of power peaks around predefined frequencies may be verified or expected variations of various vital signs may be verified. According to some embodiments of the invention, if the analysis as indicated at block 335 indicates that the desired parameters, indicators and/or other values may be computed, calculated or otherwise derived based on the acquired data then the flow may terminate successfully as indicated by block 340, in such case an indication may be issued to an operator.

According to some embodiments of the invention, if the analysis, as shown at block 335 shows that a set of parameters, indicators and/or other values cannot be derived from the acquired data, then the flow may proceed to verify the voltage applied to the LED is within range as shown by block 355, and the flow may further return to the short period of data acquisition step as indicated by block 310.

According to some embodiments of the invention, possibly following the short period of data acquisition, as indicated by block 310, if the signal is found to be saturated as shown at block 315, then the signal may be examined as indicated at block 365. According to some embodiments of the invention, and as indicated by block 380, if the signal is found to be too high then the voltage applied to the LED may be decreased by a large amount. For example, in some embodiments of the invention, the signal may be decreased by 0.5 volts. It should be noted that the step, or degree by which the voltage applied to the LED is altered may depend on parameters such as, but not limited to, the data acquisition device, ambient light, the LED type used, or the tissues measured. According to some embodiments of the invention, the voltage alteration step may be configurable, possibly by an operator of the system. In other embodiments of the invention, the data acquisition management software may use an adaptive algorithm in order to derive the best voltage alteration step. According to some embodiments of the invention, following a decrease of the voltage applied to the LED the voltage may be examined as shown by block 355. Such examination may be performed in order to verify that the voltage applied to the LED is still within operating range of the specific LED, for example between 1.7 and 4.5 volts. The flow may further return to the short period of data acquisition step as shown by block 310.

According to some embodiments of the invention, possibly following verification that the signal is not too high, the signal may be examined as indicated at block 370. According to some embodiments of the invention, as indicated by block 385, if the signal is found to be too low then the voltage applied to the LED may be increased by a large amount. For example, in some embodiments of the invention, the signal may be increased by 0.5 volts. It should be noted that the step, or degree by which the voltage applied to the LED is altered may depend on parameters such as, but not limited to, the data acquisition device, the LED type used, or the tissues measured. According to some embodiments of the invention, the voltage alteration step may be configurable, possibly by an operator of the system. In other embodiments of the invention, the data acquisition management software may use an adaptation algorithm in order to derive the best voltage alteration step. According to some embodiments of the invention, possibly following an increase of the voltage applied to the LED the voltage may be examined as shown by block 355. Such examination may be performed in order to verify that the voltage applied to the LED is still within operating range of the specific LED. The flow may further proceed to the short period of data acquisition step as shown by block 310.

According to some embodiments of the invention, if the voltage applied to the LED is not found to be too low as shown by block 370 then it may be concluded that calibration has failed. According to some embodiments of the invention, such calibration failure may comprise issuing an error indication to a user, where such indication may comprise suggestions for further actions. Such further actions may be, for example, relocating the data acquisition device, protecting the sensor from external illumination, checking connections and/or wiring, or otherwise changing and/or altering the test conditions.

According to some embodiments of the invention, following a calibration failure as shown by block 375, a user may perform corrective actions as indicated by block 390. Following such corrective actions, the flow may proceed to verify the voltage applied to the LED is within range as shown by block 355 and possibly further proceed to the short period of data acquisition step as shown by block 310. Corrective actions performed by a user or operator may comprise actions such as, but not limited to, relocating sensors, adjusting ambient light, repositioning the subject being tested or any other appropriate actions that may favorably alter test conditions.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
validating placement relative to a subject of a sensor of a data acquisition device;
calibrating said data acquisition device such that values of data acquired from said subject are within a predefined range;
instructing said subject to perform a predefined protocol;
acquiring data from said subject by said data acquisition device during performance of said predefined protocol;
verifying proper execution of said protocol by said subject based at least in part on said acquired data, wherein said verifying occurs during performance of said protocol; and
determining at least one suitability parameter based on said acquired data.

2. The method of claim 1, further comprising if said acquired data is suitable, storing said acquired data.

3. The method of claim 1, further comprising if said acquired data is suitable, communicating said acquired data to a remote computer.

4. The method of claim 1, further comprising:
computing at least one medical risk indicator based on said acquired data;

5. The method of claim 3, further comprising:
computing at said remote computer a value of at least one medical risk indicator based at least in part on said acquired data;
storing said at least one medical risk indicator; and
communicating a notification of said computation.

6. The method of claim 5, wherein communicating said notification comprises communicating said value of said at least one medical risk indicator.

7. The method of claim 5, further comprising making available to a recipient of said notification said value of said at least one medical risk indicator, wherein communicating said notification comprises communicating a test identification parameter pertaining to said subject.

8. The method of claim 7, wherein communicating said notification further comprises communicating a password and said recipient is required to provide said password to access said value of said at least one medical risk indicator.

9. The method of claim 5 wherein computing said value of said at least one medical risk indicator is based at least in part on data acquired from a plurality of subjects.

10. The method of claim 5 wherein computing said value of said at least one medical risk indicator is based at least in part on values of said at least one medical risk indicator of a plurality of subjects.

11. The method of claim 1, further comprising providing a feedback indicator to said subject during performance of said protocol based at least in part on said verifying of proper execution of said protocol by said subject.

12. The method of claim 1, further comprising if said acquired data is not suitable, providing an indication of improper execution of said protocol.

13. An apparatus comprising:
a data acquisition device to acquire data from a subject; and
a processor to receive said acquired data and to:
validate placement relative to a subject of a sensor of said data acquisition device,
calibrate said data acquisition device such that values of data acquired from said subject are within a predefined range,
receive acquired data from said data acquisition device during performance of a predefined protocol,
verify proper execution of said protocol by said subject based at least in part on said acquired data during performance of said protocol, and
determine at least one suitability parameter based on said acquired data.

14. The apparatus of claim 13, further comprising:
an output device connected to said processor to instruct said subject to perform said predefined protocol.

15. The apparatus of claim 13, further comprising:
a communication device to communicate said acquired data to a remote computer.

16. The apparatus of claim 13, further comprising a storage device to store said acquired data.

17. The apparatus of claim 13, wherein said processor is further to compute at least one medical risk indicator based on said received acquired data.

18. The apparatus of claim 13, wherein said processor is to further provide a feedback indicator to said subject during performance of said protocol based at least in part on said verifying of proper execution of said protocol by said subject.

19. A system comprising:
a data acquisition device to acquire data from a subject;
a data acquisition computer to:
validate placement relative to a subject of a sensor of said data acquisition device,
calibrate said data acquisition device such that values of data acquired from said subject are within a predefined range,
receive acquired data from said data acquisition device during performance of a predefined protocol,
verify proper execution of said protocol by said subject based at least in part on said acquired data during performance of said protocol,
determine at least one suitability parameter based on said acquired data, and
if said acquired data is suitable, communicate said acquired data to a remote computer; and
an analysis server to:
receive said acquired data,
compute a value of at least one medical risk indicator based at least in part on said received acquired data, and
communicate a notification of said computation.

20. The system of claim 19, further comprising a storage device in communication with said analysis server to store said value of at least one medical risk indicator.

21. The system of claim 20, wherein said storage device is further to store data acquired from a plurality of subjects.

22. The system of claim 21, wherein said analysis server is to compute said value of said at least one medical risk indicator based at least in part on data acquired from a plurality of subjects.

23. The system of claim 21, wherein said analysis server is to compute said value of said at least one medical risk indicator based at least in part on a value of said at least one medical risk indicator from a plurality of subjects.

24. The system of claim 19, wherein said analysis server is further to make available to a recipient of said notification said value of said at least one medical risk indicator, and wherein said notification includes a test identification parameter pertaining to said subject.

25. The system of claim 24, wherein said notification further includes a password and wherein said analysis server is further to require said password to permit access to said value of said at least one medical risk indicator.
